(19) United States
(12) Patent Application Publication
(10) Pub. No.: US 2023/0309203 A1
(43) Pub. Date: Sep. 28, 2023

(54) METHOD FOR OPERATING AN INDUCTION COOKTOP AND INDUCTION COOKTOP

(71) Applicant: E.G.O. Elektro-Geraetebau GmbH, Oberderdingen (DE)

(72) Inventors: Stephane Lomp, Gambsheim (FR); Christian Egenter, Bretten (DE); Elmar Herweg, Oberderdingen (DE)

(21) Appl. No.: 18/180,235

(22) Filed: Mar. 8, 2023

(30) Foreign Application Priority Data
Mar. 22, 2022 (DE) 10 2022 202 805.8

(51) Int. Cl. H05B 6/12; H05B 6/06; H05B 1/02; H05B 6/36

(52) U.S. Cl. CPC H05B 6/1272; H05B 1/0266; H05B 6/065; H05B 6/362

(57) ABSTRACT

In order to operate an induction cooktop with a cooktop plate, at least two induction heating coils thereunder, a cooktop controller, and a power unit for supplying power to the induction heating coils, the two induction heating coils are jointly supplied with power and operated with in each case one power density spectrum with precisely one maximum. In a first operating mode, the power density spectra are measured and it is established how their respective maxima are located relative one another, and the sum thereof is formed. The difference in power density between a local minimum of the sum, which is located between the two maxima of the sum, and the two maxima of the sum is then reduced. To this end, the switch-on time and/or the switch-off time of at least one of the circuit-breakers is varied in order to actively modify the power density spectrum of the power supply.

### CROSS-REFERENCE TO RELATED APPLICATIONS

This application claims priority to German Application No. 10 2022 202 805.8, filed Mar. 22, 2022, the contents of which are hereby incorporated herein in its entirety by reference.

### FIELD OF APPLICATION AND PRIOR ART

The invention relates to a method for operating an induction cooktop and to an induction cooktop configured to carry out this method, wherein the intention is to minimize any noise generation which arises.

WO 2016/010492 A1 discloses an induction cooktop which has a cooktop plate and a plurality of induction heating coils thereunder. A cooktop controller and a power unit, which comprises a plurality of circuit-breakers, for supplying the induction heating coils with power are furthermore provided. An LC filter is provided to prevent unwanted (random) noise due to certain frequencies. An attempt is furthermore made to identify a common switching frequency when operating a plurality of induction heating coils.

### PROBLEM AND SOLUTION

The problem underlying the present invention of providing a method and an induction cooktop as stated above with which prior art problems can be solved and with which it is in particular possible to improve noise generation during operation of such an induction cooktop, in particular with a plurality of induction heating coils which are arranged adjacent one another.

This problem is solved by a method having the features of claim 1 and by an induction cooktop having the features of claim 15. Advantageous and preferred developments of the invention are the subject of the additional claims and are explained in more detail below. Some of the features are here described only for the method or only for the induction cooktop. However, irrespective thereof, they are intended to apply by themselves and independently of one another both to the method and to such an induction cooktop. The wording of the claims forms part of the content of the description by explicit reference.

The induction cooktop has a cooktop plate and at least two induction heating coils thereunder. A relatively large number of induction heating coils, preferably six, eight or up to twenty induction heating coils, is advantageous. The induction cooktop furthermore has a cooktop controller, in particular with a display and an operating means for an operator, together with a power unit which supplies the induction heating coils with power. The power unit is triggered by the cooktop controller and has a plurality of circuit-breakers which may in turn be triggered by way of parameters such as switch-on time and/or switch-off time. This may proceed in known manner. The power unit can be connected to a line voltage and be configured to generate from the line voltage a higher frequency triggering voltage for supplying the induction heating coils with power by way of the stated circuit-breakers.

Coupling via a common intermediate circuit voltage or due to the magnetic field of the inductors may lead to interference between the power density spectra of the coupled induction heating coils. If the power spectra overlap without a pronounced minimum, wideband interference noise arises which users normally perceive as troublesome. If, on the other hand, the power density spectra have a pronounced local minimum between them, frequency ranges are missing from the spectrum of audible interference, which users normally consider to be a troublesome, unpleasant noise. If the maxima of the power density spectra of the induction heating coils are located a number of kHz apart from one another, no low-frequency interference occurs.

Human hearing is particularly sensitive to sound pressure levels in the range below 1 kHz to 5 kHz. Narrowband noise is considered to be more intense than wideband noise. The absence of frequencies from otherwise wideband noise is likewise subjectively considered to be troublesome.

According to the invention, the power density spectra of the power supply of the at least two induction heating coils which are to be simultaneously operated are estimated or measured. The coils may be provided for in each case different cooking vessels, or possibly also just one cooking vessel, placed on the cooktop plate. In this case, they can, together with further induction heating coils, heat both cooking vessels placed thereon. Each of the power density spectra has a maximum, in particular precisely one single maximum. In a first operating mode, the switch-on time and/or the switch-off time of at least one of the circuit-breakers is then varied in order to actively modify the power density spectrum of the power supply of at least one induction heating coil, in particular of precisely one single induction heating coil, in such a manner that the two power density spectra of the power supply overlap more or that the two maxima come closer together and thus have a smaller distance or smaller frequency difference between them. Alternatively or additionally, a resultant sum of the two power density spectra can be formed. This is relatively simple to carry out. The difference in power density between a local minimum of the sum, which is located between the two maxima of the sum, and the two maxima of the sum is then reduced. This may for example proceed in that the two power density spectra are shifted closer together, in particular the power density spectrum with the maximum at the higher frequency is shifted toward lower frequencies. As a consequence, the minimum of the power density of the resultant sum located therebetween is automatically raised.

It is thus also possible to ensure that the minimum or a frequency reduction between the two maxima becomes smaller. The smaller is the difference between the minimum and the maxima, the less noise is generated, as has been found in the context the invention. The difference of the minimum relative to one of the maxima should be at most 40 dB and advantageously less, preferably at most 20 dB. They particularly advantageously amount to at least 5 dB or 10 dB, such that they are of a specific, relevant size. A resultant sum of the at least two different power density spectra of the power supply is formed with a local minimum of the curve of the sum which is located between the two maxima of the sum. At least one of the power density spectra of the power supply is here actively modified as described above with regard to the difference.

It is in principle possible to modify just one of the two power density spectra, i.e. in a power supply for just one of the induction heating coils. Alternatively, both can also be modified, in particular toward one another. At conventional operating points for induction heating coils, power output can be increased by lower frequencies, i.e. a longer sum of switch-on time plus switch-off time. Power can be reduced again by simultaneously reducing switch-on time, such that power can remain approximately constant by balancing the two measures. Wobbling, i.e. a periodic variation in frequency, gives rise to a power density spectrum which can be determined for example by measuring the current profile through an induction heating coil or the voltage profile at the resonant capacitor over the course of one wobble period.

One development of the invention can provide actively modifying the power density spectra of the power supply in the stated first operating mode in such manner that, as a result, no local minimum of the power density spectra is any longer present between the two maxima. It can be provided to this end that the two maxima differ by at most 10%, should advantageously be of identical or similar size, or their difference from one another is less than the difference from the local minimum. Under certain circumstances, a frequency shift may thus proceed in such a manner that the two maxima are identical.

It is possible for the two induction heating coils to be jointly supplied with power and so operated with in each case one power density spectrum with in each case precisely one single maximum, as has previously been explained. The power density spectra of the power supply for the two induction heating coils are measured or estimated in order to establish whether the two power density spectra in each case overlap or how these two power density spectra are each located relative to each other with regard to their respective maximum. Two cases may then be differentiated.

In a first case, the two power density spectra are located such that the two maxima are more than 5 kHz apart, in particular more than 2 kHz apart. Power supply to the induction heating coils is not modified here. It is then assumed that noise generation is not too great or not very troublesome.

In a second case, the two maxima are located closer together, such that the two maxima are no more than 5 kHz apart, but instead less, in particular no more than 2 kHz apart. They should, however, also not be identical. In the common power density spectrum or in the above-stated sum of the two power density spectra, a local minimum or a frequency reduction then occurs between the two maxima. Just one single local minimum arises here. In this second case, the power supply to the induction heating coils is then modified, and a “wobble” generated for at least one power density spectrum, as mentioned above, to which end the parameters switch-on time and/or switch-off time of at least one of the circuit-breakers are modified, preferably periodically modified. Such wobbling is known from EP 1734789 A1, to which explicit reference is hereby made. Wobbling is considered to be a periodic or recurrent modification of the frequency of an oscillator or resonant circuit over an adjustable range, sometimes for measurement purposes but here simply for variation. This is intended to ensure that the power density spectra together with their maxima are modified in order to avoid a frequency reduction or a minimum therebetween such that their relationship to one another with regard to their respective maximum corresponds to the first case. It may in general be provided in this development that a minimum is defined in that it is located at least 20% below the maximum or one of the two maxima, preferably at least 40% therebelow.

One possible development of the invention can provide that active modification of the power supply to the induction heating coils in the stated second case proceeds in such a manner that a modification proceeds from one single higher frequency to one single lower frequency. A measured frequency reduction or a minimum can accordingly be reduced and/or eliminated.

One possible advantageous development of the invention may provide that the above-stated first case is also considered to prevail when the maxima of the two power density spectra are more than 2 kHz up to 4 kHz apart, and the frequency difference is thus of the same size. In the case of such slight differences between the maxima, there is no need to modify one of the power density spectra. Experience has shown that there is then no need to fear any appreciable noise generation.

One development of the invention can provide that the method is used for three induction heating coils, i.e. three induction heating coils are operated which are arranged adjacent one another without further induction heating coils therebetween, i.e. directly adjacent. The parameters of the circuit-breakers provided or used for them are appropriately varied such that no maxima are obtained which are more than 5 kHz apart with a frequency reduction or with a minimum between the maxima. To this end, three maxima are then considered relative to one another.

In a further development of the invention, an active modification of the power supply of the induction heating coils in the second case may be a modification of the power density spectrum of the induction heating coil operated with the higher frequency triggering from higher frequency components toward lower frequency components such that the local minimum relative to two maxima of the resultant sum is reduced and/or eliminated. A simple and practical method is accordingly obtained.

In a further development of the invention, it is additionally possible to modify a predetermined power setpoint for the induction heating coil. Modification of the power setpoint is limited to less than 15%, since a user generally perceives a small modification to be immaterial. A cooktop controller can also more strongly reduce the power of an induction heating coil if noise optimization is considered to take priority over power accuracy. It is accordingly possible to ensure that the power density spectra overlap in such a manner that they correspond to the first case. However, this should advantageously only be done after other options for influencing, i.e. for example if these options achieve too slight an effect. Modifying the power on at least one of the induction heating coils is in itself a certain intervention in the operation of the induction heating coils which under certain circumstances is more troublesome than noise generation. If the power on one of the induction heating coils is modified, this should proceed in the induction heating coil with the higher power setpoint, i.e. the power thereof should be reduced such that the frequency difference between the two maxima corresponds to the first case. This is less hazardous or critical than increasing the power in the other induction heating coil.

In one development of the invention, the at least two induction heating coils may be arranged adjacent one another, in particular without a further induction heating coil therebetween, wherein the at least two induction heating coils are preferably of rectangular or polygonal configuration. They can extend with at least one side or longitudinal side adjacent one another and approximately parallel to one another. The at least two induction heating coils are preferably of identical configuration and particularly preferably all the induction heating coils of an induction cooktop are of identical configuration.

Advantageously, three induction heating coils which are arranged adjacent one another without further induction heating coils therebetween are operated using the method. The parameters of their circuit-breakers are here appropriately varied such that the maxima of the three power density spectra of the power supply of the three induction heating coils are no more than 5 kHz apart, wherein in each case precisely one local minimum is located between in each case two maxima of the three maxima.

In a further development of the invention, the power density spectra can be determined by measuring the voltage of a capacitor connected in parallel to the induction heating coil or by measuring the current through the induction heating coil. This is practicable to carry out.

The induction cooktop according to the invention is thus configured as previously described and has an above-stated power unit and a cooktop controller which are configured for carrying out the method according to one of the preceding claims. Power density spectra can accordingly be monitored and, once the cases have been differentiated as described, optionally influenced.

The power unit has an antiresonant circuit with at least one circuit-breaker which may in particular be a transistor or an IGBT. The power unit is here configured for operation of the at least one circuit-breaker as a quasi-resonant inverter. Both half-bridge and full-bridge circuits may be used.

In a further development, the power unit may have a rectifier which is connected to a line voltage. Two or more identical circuit branches, each of which has an LC member, are connected to the rectifier, wherein an induction heating coil, a resonant circuit coil and a circuit-breaker, in particular an above-described circuit-breaker, are connected thereto.

A still further development may provide that the circuit branches are isolated from the rectifier by way of an inductor. For each rectifier, precisely one inductor can here be provided between rectifier and circuit branch.

These and other features emerge from the description and the drawings, in addition to the claims, wherein the individual features can be realized in themselves either alone or severally in the form of sub-combinations in one embodiment of the invention and in other areas, and can constitute advantageous embodiments eligible for protection in themselves, for which protection is sought here. The subdivision of the application into individual sections and sub-headings does not limit the statements made thereunder in their general validity.

### BRIEF DESCRIPTION OF THE DRAWINGS

Exemplary embodiments of the invention are explained in more detail in the below and are shown schematically in the drawings, in which:

FIG. 1 shows an induction cooktop according to the invention with a plurality of induction heating coils,

FIG. 2 shows a power density spectrum 1 of the power supply for an induction heating coil 1 with a maximum at f1,

FIG. 3 shows a power density spectrum 2 of the power supply for an induction heating coil 2 with a maximum at f2,

FIG. 4 shows the power density spectra 1 and 2 and the sum of the power density spectra together,

FIG. 5 shows the curve of the sum of the power density spectra alone,

FIG. 6 shows a flow chart describing the method according to the invention,

FIG. 7 shows the curve of the sum of power density spectra 1 and 2′, wherein power density spectrum 2 has been shifted onto power density spectrum 1, and

FIG. 8 shows the curve of the sum of power density spectra 1 and 2′, wherein power density spectrum 2 has been not entirely shifted onto power density spectrum 1.

### DETAILED DESCRIPTION OF THE EXEMPLARY EMBODIMENTS

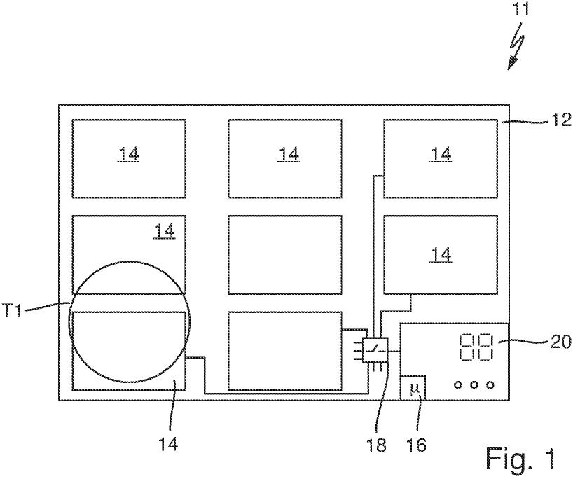

FIG. 1 shows an induction cooktop 11 according to the invention with a cooktop plate 12 and a plurality of induction heating means 14 thereunder which are configured as conventional induction heating coils. Eight induction heating means 14, all of which are the same size or of identical configuration, are here arranged in a regular pattern. The induction cooktop 11 has a cooktop controller 16, a power supply 18 and an operating means 20 which also has display functions, as is generally known. The power unit 18 is configured as explained above and substantially as known from the prior art, i.e. with circuit-breakers, for example IGBTs. The power unit 18 is of conventional configuration. It may have a plurality of bridge circuits of the above-stated type and is connected to each of the induction heating means 14 to supply them with power.

A pan T1 is placed on the two left front induction heating means 14, wherein the coverage on the front induction heating means 14 is somewhat greater than on the middle induction heating means. The pan T1 is to be heated jointly by the two heating means 14. An operator has to this end set a power level P1 via the operating means 20. Due to the different coverages, different working frequencies are established despite the similar power setpoint, and unpleasant interference noise may arise between the two heating means 14. This should, if possible, be reduced. It is, however, immaterial for the purposes of the invention whether the frequency differences between the heating means 14 are caused by differences in coverage of one single pan T1 with the same power level P1 or by a plurality of pans T1, T2 with different power levels P1, P2 and/or coverages.

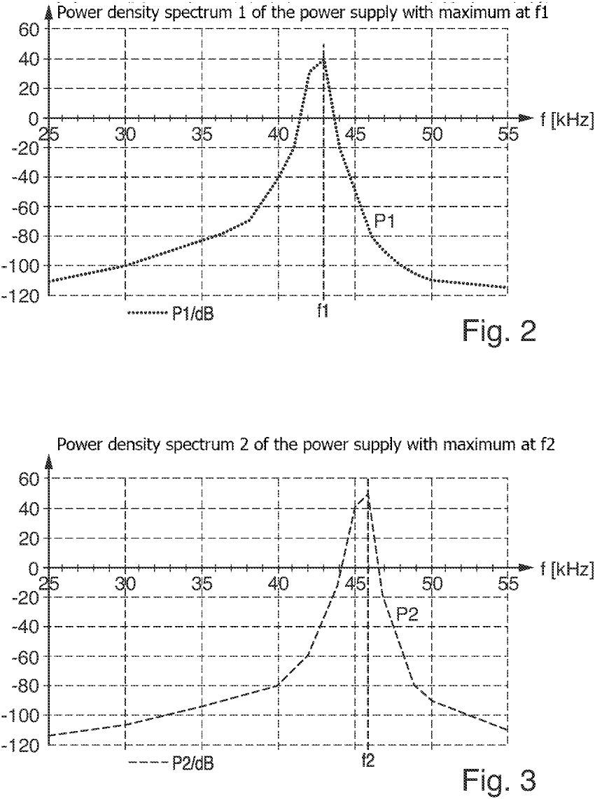

FIG. 2 shows the power density spectrum 1 of the power supply for the front left induction heating means 14 under pan T1. The power density spectrum 1 has a maximum of 40 dB at frequency f1 = 43 kHz.

Similarly to FIG. 2, FIG. 3 shows the power density spectrum 2 of the power supply for the middle and also for the rear induction heating means 14. A maximum of approximately 48 dB is here present at a frequency f2 = 46 kHz. Purely with regard to shape, the two power density spectra 1 and 2 of FIGS. 2 and 3 are similar in appearance but are not entirely identical. Furthermore they are also not mirror-symmetrical to the vertical axis at the frequency of the maximum. These curves of FIG. 2 and FIG. 3 are either the envelopes of spectra actually obtained by FFT or alternatively, the stated spectra can also be smoothed.

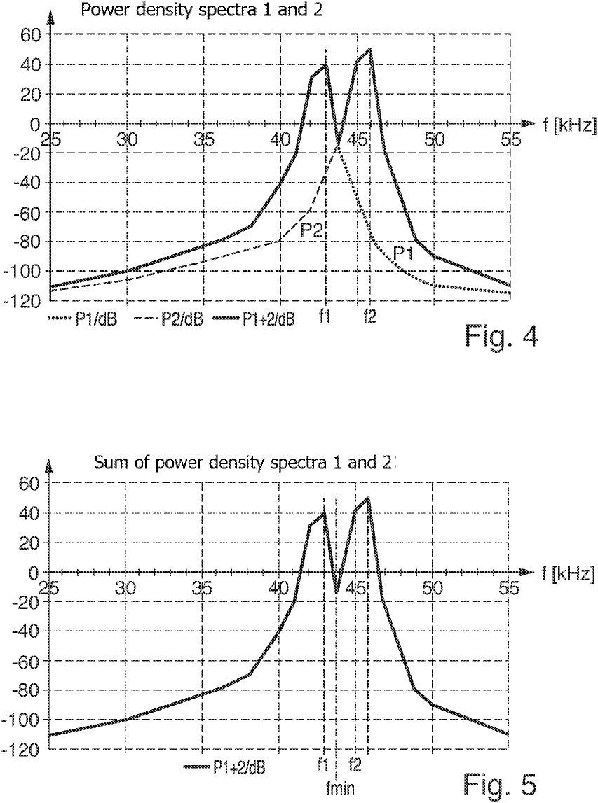

For clarity, FIG. 4 once again shows power density spectra 1 and 2 on one diagram together with the curve obtained therefrom of the sum of the power density spectra. To provide a better illustration, FIG. 5 shows only the sum of the power density spectra. It has two relative maxima at f1 and f2 with the frequency difference here amounting to approximately 3 kHz. A local minimum in the sum at fmin of approximately 44 kHz is located between f1 and f2. At approximately -10 dB, it is located approximately 50 dB below the maximum at f1 and approximately 58 dB below the maximum at f2. The two maxima f1 and f2 are located approximately 3 kHz apart.

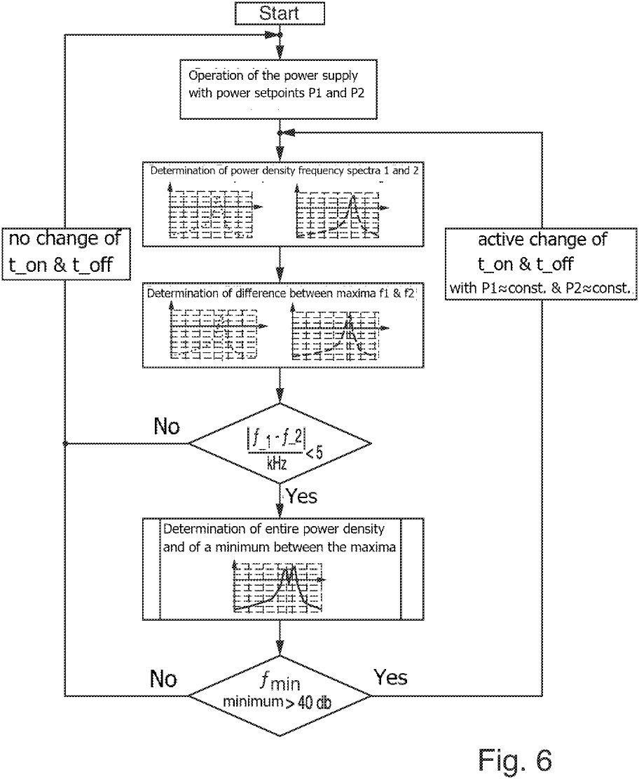

According to the flow chart of FIG. 6, the method for operating the induction cooktop 11 starts with the induction heating means 14. Two setpoints of power levels P1 and P2 for heating pans T1 and T2 are input via the operating means 20 as has previously been explained. The power supply 18 and the cooktop controller 16 then ascertain the frequency spectra 1 and 2 of the power densities, i.e. the power density spectra 1 and 2, for the power density at the two operated induction heating means 14. This corresponds respectively to FIGS. 2 and 3.

In the next step, a difference between the maxima f1 and f2 is ascertained, see FIG. 4. In the present case, this is 3 kHz, and the absolute value of 3 is thus less than the 5 stated above in the condition as an amount of 5 kHz difference between the maxima. If the difference in amount were greater than 5, the two maxima would be so far part that noise generation would in any event be perceived as relatively slight. No intervention would then have to be made, such that the power supply remains the same and in particular the switch-on times and switch-off times and the power density spectra remain unchanged.

However, as has previously been explained, since the difference in amount of 3 is smaller than a value of 5, the method is continued by determining the entire power density or the sum corresponding to FIG. 5 is determined. It is then verified as the next condition whether there is a local minimum located between the two maxima f1 and f2, i.e. fmin, of more than 40 dB below f1 and/or f2. Such is discernibly the case in FIG. 5, indeed the minimum is located even more than 50 dB therebelow. If this were not the case, there would likewise be no need to modify the power supply. However, since such is the case here, the switch-on times and switch-off times of the circuit-breakers (not shown) in the power unit 18 are actively changed. In so doing, the attempt is made to keep power P1 and power P2 approximately constant or not to modify it too much. The procedure used here was to modify the power density spectrum 2 for the induction heating coils 14 under pan T2, namely the frequencies were reduced or the second maximum f2 was brought together with the first maximum f1 or alternatively shifted to 43 kHz. As a result, there is thus no longer any difference or at least no measurable difference. While the first condition from the flow chart of FIG. 6 is indeed still met, there is then however quite clearly no longer any appreciable local minimum of the combined sum, in particular no difference of at least 40 dB relative to the maximum. Operation can thus continue at this power setpoint which has been modified according to the invention. Noise reduction has been successfully achieved. This is shown in FIG. 7 with the power density spectra 1 and 2′, wherein power density spectrum 2′ has been shifted leftward up to power density spectrum 1. They are thus congruent. In practice, this would indeed be achievable only rarely or with difficulty. It does, however, serve to illustrate the general possibility of shifting a power density spectrum in order to reduce the frequency difference between the local minimum and the two adjacent maxima. In this case, the sum does not any longer even have a local minimum.

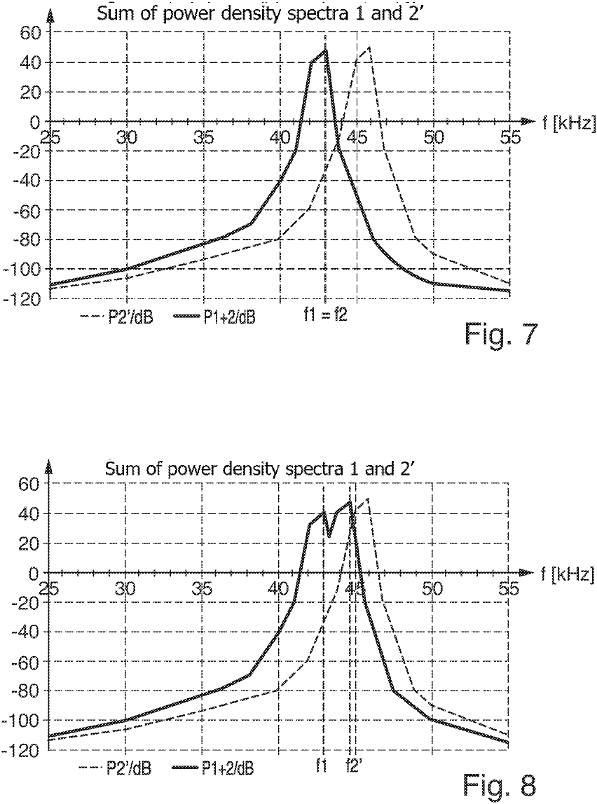

FIG. 8 shows a further possibility for shifting a power density spectrum. In this case, power density spectrum 2 has been shifted by approximately 1.5 kHz leftward. The original power density spectrum 2 is shown as a dashed line, the shifted power density spectrum 2′ is actually adjacent to the left. The sum of power density spectra 1 and 2′ is shown as a continuous line. It is clearly apparent here that there is still a local minimum between the two maxima at frequencies f1 and f2′, but the difference relative to the two maxima is considerably less than in the sum according to FIG. 5. It amounts to approximately 18 dB relative to the maximum of power density spectrum f1 and approximately 23 dB to that of power density spectrum f2′. The two maxima at frequencies f1 and f2′ are located approximately 1.8 kHz apart, i.e. less than 2 kHz. This case of FIG. 8 is considerably more realistic than that of FIG. 7, see the above explanation.

The focus on the difference between the maxima at f1 and f2 and the determination of the presence and size of the local minimum therebetween are very straightforward to achieve in metrological and computational terms. As a result, the method is advantageous and practical to implement.

The term spectral power density can generally also be used instead of power density spectrum. As an alternative to evaluating a power density spectrum or a spectral power density, it is accordingly also possible to evaluate a signal spectrum. The signals are namely effective value measurements (root mean square of the measured signal) of voltage at the induction heating coil or of current through the induction heating coil. Where signal spectra are used instead of power density spectra, the stated dB limit values should be halved in accordance with the known logarithmic rule for dB signal versus dB power.

A power density spectrum represents the distribution of the power components of a signal over frequency and can be ascertained by FFT over a time interval, preferably a periodic time interval. This time interval may be a whole, half or multiple of a line voltage period.

1. A method for operating an induction cooktop, wherein said induction cooktop comprises:
a cooktop plate,
at least two induction heating coils under said cooktop plate,
a cooktop controller,
a power unit for a power supply for said induction heating coils, wherein said power unit:
is triggered by said cooktop controller,
has a plurality of circuit-breakers which can be triggered by way of parameters as switch-on time and/or as switch-off time,
is configured to generate from a line voltage a higher frequency triggering for said power supply for said induction heating coils, wherein
power density spectra of said power supply of said two induction heating coils are estimated or measured, wherein each said power density spectrum has a maximum at a frequency,
in a first operating mode, said switch-on time and/or said switch-off time of at least one of said circuit-breakers is varied in order to actively modify said power density spectrum of said power supply in such a manner that said two power density spectra of said power supply for said two induction heating coils overlap more or that a frequency difference between said two maxima is reduced and/or that a resultant sum of said two power density spectra is formed and a difference in power density between a local minimum of said resultant sum and said maxima of said resultant sum is reduced, wherein said local minimum is located between said two maxima of said resultant sum.

2. The method of claim 1, wherein said resultant sum of said two power density spectra is used instead of individual power density spectra.

3. The method of claim 1, wherein a resultant sum of said two different power density spectra of said power supply is formed with a local minimum of said sum, which local minimum is located between said two maxima of said sum, and wherein at least one of said power density spectra of said power supply is actively modified in such a manner that a difference between said local minimum and said maxima amounts to at most 40 dB or less.

4. The method of claim 1, wherein, in said first operating mode, said power density spectra of said power supply are actively modified in such a manner that, as a result, no pronounced local minimum is present between said two maxima of said power density spectra.

5. The method of claim 4, wherein said two maxima of said power density spectra differ by at most 10%.

6. The method of claim 4, wherein said two maxima of said power density spectra are of identical size or are smaller than a difference from said local minimum.

7. The method of claim 1, wherein said two induction heating coils are simultaneously supplied with power and operated with in each case one power density spectrum with precisely one maximum of said power density,
wherein said power density spectra for said two induction heating coils are measured or estimated and it is established whether said two power density spectra in each case overlap or how said two power density spectra are each located with regard to a frequency of their respective maximum,
wherein, in a first case, in which said two power density spectra are located such that said two maxima are more than 5 kHz apart, said power supply of said induction heating coils is not modified,
wherein, in a second case, in which said two power density spectra are located such that said two maxima are no more than 5 kHz apart and wherein, in a resultant sum of said two power density spectra, a pronounced local minimum arises between said two maxima, said power supply of said induction heating coils is modified and a wobble is generated in said power supply of at least one induction heating coil and said parameter switch-on time and/or said parameter switch-off time of at least one of said circuit-breakers is modified such that a sum of said power density spectra with said maxima changes such that said local minimum between said two maxima is increased or a difference of said power density at said local minimum from said power densities of said two maxima becomes smaller.

8. The method of claim 7, wherein said first case is still considered to prevail if said frequency difference between said two maxima amounts to more than 2 kHz to 4 kHz.

9. The method of claim 7, wherein an active modification of said power supply of said induction heating coils in said second case is a modification of said power density spectrum of said induction heating coil operated with said higher frequency triggering from higher frequency components toward lower frequency components such that said local minimum relative to said two maxima of said resultant sum is reduced and/or eliminated.

10. The method of claim 7, wherein a predetermined power setpoint for at least one of said induction heating coils is modified in order to enable overlapping in said second case, if this is otherwise not possible without modifying said instantaneous power by more than 2%.

11. The method of claim 7, wherein said power setpoint of said induction heating coil with said higher power setpoint is modified such that said frequency difference between said two maxima corresponds to said first case.

12. The method of claim 1, wherein said at least two induction heating coils are arranged adjacent one another without a further induction heating coil therebetween, wherein said at least two induction heating coils are of rectangular or polygonal configuration and extend with at least one side or longitudinal side adjacent one another and approximately parallel to one another.

13. The method of claim 1, wherein three induction heating coils which are arranged adjacent one another without further induction heating coils therebetween are operated therewith, wherein said parameters of their circuit-breakers are appropriately varied such that said maxima of said three power density spectra of said power supply of said three induction heating coils are no more than 5 kHz apart with in each case precisely one said local minimum between in each case two said maxima of said three maxima.

14. The method of claim 1, wherein said power density spectra are determined by measuring said voltage of a capacitor connected in parallel to said induction heating coil or by measuring a current through said induction heating coil.

15. An induction cooktop with:
a cooktop plate,
at least two induction heating coils under said cooktop plate,
a cooktop controller,
a power unit for a power supply to said induction heating coils which is triggered by said cooktop controller, wherein said power unit has a plurality of circuit-breakers which can be triggered by way of said parameters switch-on time and/or switch-off time, and is connected to a line voltage and is configured to generate from said line voltage a higher frequency triggering for supplying said induction heating coils with power,
wherein said power unit and said cooktop controller are configured for carrying out said method of claim 1.

16. The induction cooktop of claim 15, wherein said power unit has an antiresonant circuit with at least one circuit-breaker per said induction heating coil.

17. The induction cooktop of claim 16, wherein said power unit is configured for operation of said at least one circuit-breaker as a quasi-resonant inverter.

18. The induction cooktop of claim 15, wherein said power unit has a rectifier for connection to a line voltage, wherein two identical circuit branches, each of which has an LC member, are connected to said rectifier, wherein an induction heating coil, a resonant circuit capacitor and a circuit-breaker are connected thereto.

19. The induction cooktop of claim 18, wherein said circuit-breaker is a power semiconductor switch.

20. The induction cooktop of claim 15, wherein said circuit branches are in each case isolated from said rectifier by way of an inductor or filter choke.

21. The induction cooktop of claim 20, wherein precisely one dedicated said inductor is provided between said rectifier and each said circuit branch.
